(19) United States
(12) Patent Application Publication
(10) Pub. No.: US 2018/0084555 A1
(43) Pub. Date: Mar. 22, 2018

(54) WIRELESS COMMUNICATION DEVICE, WIRELESS COMMUNICATION TERMINAL AND WIRELESS COMMUNICATION METHOD

(71) Applicant: KABUSHIKI KAISHA TOSHIBA, Tokyo (JP)

(72) Inventors: Hiroki MORI, Kawasaki (JP); Seiya KISHIMOTO, Tokyo (JP); Tomoya TANDAI, Tokyo (JP)

(73) Assignee: KABUSHIKI KAISHA TOSHIBA, Tokyo (JP)

(21) Appl. No.: 15/453,144

(22) Filed: Mar. 8, 2017

(30) Foreign Application Priority Data
Sep. 20, 2016 (JP) 2016-183282

(51) Int. Cl. H04W 72/04; H04W 72/08; H04W 74/08

(52) U.S. Cl. CPC H04W 72/0493; H04W 88/02; H04W 74/0816; H04W 72/082

(57) ABSTRACT

According to one embodiment, a wireless communication device includes: a memory configured to store a plurality of radiation pattern selection policies on an antenna capable of changing a radiation pattern; and processing circuitry configured to detect an interference signal of a first channel by analyzing a signal received via the antenna; and select the radiation pattern selection policy from among the plurality of radiation pattern selection policies based on the interference signal of the first channel and change the radiation pattern of the antenna in accordance with the selected radiation pattern selection policy.

### CROSS-REFERENCE TO RELATED APPLICATIONS

This application is based upon and claims the benefit of priority from Japanese Patent Application No. 2016-183282, filed on Sep. 20, 2016; the entire contents of which are incorporated herein by reference.

### FIELD

Embodiments described herein relate to a wireless communication device, a wireless communication terminal and a wireless communication method.

### BACKGROUND

In a wireless LAN (Local Area Network), a CSMA/CA (Carrier Sense Multiple Access/Collision Avoidance) scheme is used. In the CSMA/CA scheme, the state of a wireless medium is checked by carrier sensing, and, when the state is idle, an access right is acquired to perform frame transmission.

In a wireless LAN, there may be a case where an operating channel is changed depending on a congestion condition of the operating channel, handover and the like. In this case, as an example of an operation of an access point, an operation of notifying the change of the operating channel to terminals by broadcasting a channel switching signal to the terminals is given. For example, in IEEE 802.11h, it is possible for the terminals to perform channel change without performing association again, by receiving the channel switching signal from the access point.

However, when a device which continues emitting a radio wave (an interference signal), such as an analog video camera and an analog telephone, exists near the access point, it is difficult for the access point to acquire an access right. In this case, the access point cannot transmit a channel switching signal, or it takes a long time before the access point can transmit a channel switching signal. When the access point compulsorily performs switching of the operating channel without transmitting a channel switching signal, each terminal is required to perform an association process with the access point again, and it take a time until communication becomes possible. Thus, existence of a device which continues emitting an interference signal becomes an obstacle to communication of a wireless LAN system.

### BRIEF DESCRIPTION OF THE DRAWINGS

FIG. 1 is a block diagram of a wireless communication device according to a first embodiment;

FIG. 2 is a block diagram of an interference detector according to the first embodiment;

FIG. 3 is a diagram showing an example of time-frequency data according to the first embodiment;

FIG. 4 is a diagram schematically showing an example of features and an example of binary tree used to determine a device category of an interference source by a classifier according to the first embodiment;

FIG. 5 is a flowchart of an operation by the wireless communication device according to the first embodiment;

FIG. 6 is a flowchart continued from FIG. 5;

FIG. 7 is a diagram showing an example of a state in which interference is detected;

FIG. 8 is a diagram showing an example of changing a radiation pattern and continuing communication through the same channel;

FIG. 9 is a diagram showing an example of changing the radiation pattern and transmitting a channel switching signal through the same channel;

FIG. 10 is a diagram showing an example of a state in which the wireless communication device and a part of terminals have switched the channel;

FIG. 11 is a diagram showing a state in which remaining terminals have switched the channel;

FIG. 12 is a flowchart of an operation according to a first modification;

FIG. 13 is a flowchart of an operation according to a second modification;

FIG. 14 is a functional block diagram of an access point or a terminal according to a second embodiment;

FIG. 15 is a diagram showing a whole configuration example of the terminal or a base station;

FIG. 16 is a diagram showing a hardware configuration example of a wireless communication device mounted on the terminal or the base station;

FIG. 17 is a perspective view of a wireless communication terminal according to the embodiment of the present invention;

FIG. 18 is a diagram showing a memory card according to the embodiment of the present invention; and

FIG. 19 is a diagram showing an example of frame exchange during a contention period.

### DETAILED DESCRIPTION

According to one embodiment, a wireless communication device includes: a memory configured to store a plurality of radiation pattern selection policies on an antenna capable of changing a radiation pattern; and processing circuitry configured to detect an interference signal of a first channel by analyzing a signal received via the antenna; and select the radiation pattern selection policy from among the plurality of radiation pattern selection policies based on the interference signal of the first channel and change the radiation pattern of the antenna in accordance with the selected radiation pattern selection policy.

Embodiments of the present invention will be described below with reference to drawings. In the drawings, the same components will be given the same reference numerals, and description thereof will be appropriately omitted.

### First Embodiment

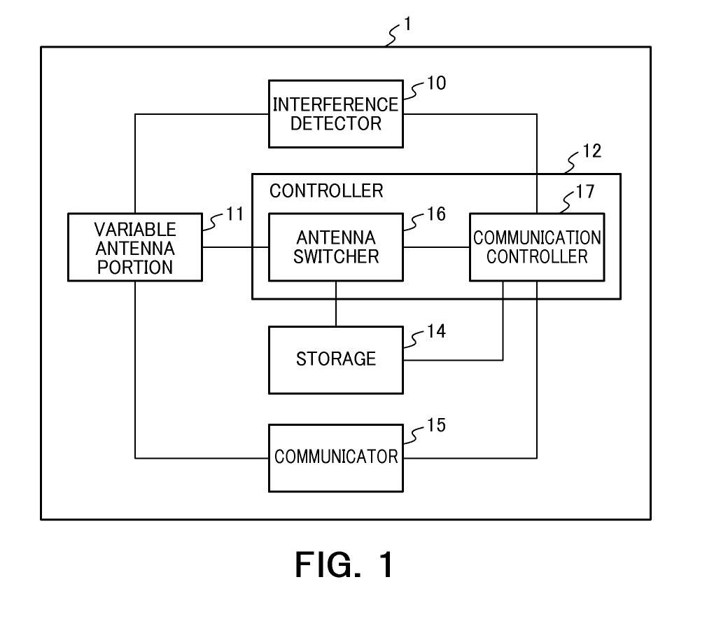

FIG. 1 is a block diagram showing an example of a wireless communication device according to the present embodiment. A wireless communication device 1 is provided with an interference detector 10, a variable antenna portion 11, a controller 12, a storage 14 and a communicator 15. The controller 12 is provided with an antenna switcher 16 and a communication controller 17.

The wireless communication device 1 is, for example, an access point (hereinafter also referred to as a base station) constituting a wireless LAN and is a device which transmits and receives frames to and from a partner wireless communication device using a wireless medium such as a radio wave. The partner wireless communication device is a wireless communication terminal belonging to a network formed by the access point (BSS: Basic Service Set). Hereinafter, the wireless communication terminal may be referred to as a terminal, a communication terminal or an STA (station). The access point (base station) has functions similar to those of a station except that the access point has a relay function and the like and, therefore, is in one form of a wireless communication terminal. In a case of mentioning a non-base station terminal, it refers to a station. In a case of merely mentioning a wireless communication terminal (terminal), it may refer to not only a station but also an access point.

Though the wireless communication device 1 is assumed to be an access point in the present embodiment, the wireless communication device 1 is not limited to an access point. For example, the wireless communication device 1 may be a terminal or may be a wireless communication device other than a wireless LAN communication device.

The wireless communication device other than a wireless LAN communication device will be described. In a wireless LAN communication device, an LBT (Listen before Talk) scheme is adopted. Specifically, a CSMA/CA (Carrier Sense Multiple Access/Collision Avoidance) scheme is used. In the CSMA/CA scheme, the state of a wireless medium is checked by carrier sensing, and, when the state is an idle state, a right of access to the wireless medium is acquired to perform frame transmission. The wireless communication device according to the present embodiment may be a wireless communication device other than a wireless LAN communication device if the wireless communication device constitutes a system using such an LBT scheme. As an example of a system using the LBT scheme other than a wireless LAN system, an LAA (Licensed Assisted Access using LTE (Long Term Evolution)) system is given. The LAA is a scheme for performing LTE communication using a frequency band which does not require license.

The variable antenna portion 11 is provided with one or more antennas for transmitting and receiving radio waves. The variable antenna portion 11 radiates a wireless frequency signal supplied from the communicator 15 into space as a radio wave. Further, the variable antenna portion 11 outputs a wireless frequency signal received from the space to the interference detector 10 and the communicator 15.

Here, the variable antenna portion 11 has a plurality of radiation patterns and can change its radiation patterns by switching antenna settings. The radiation pattern is also referred to as a beam pattern. Hereinafter, the patterns will be referred to as radiation patterns. As examples of the radiation pattern, an omnidirectional pattern, a pattern having directivity in a particular direction and the like are given. A pattern obtained by arbitrarily combining (overlapping) the patterns is also possible.

An example of a structure of an antenna capable of changing its radiation pattern will be described. As an example, a configuration is given in which one antenna has a plurality of branches, and directivity of the antenna is controlled by controlling impedance or resistance of each branch. For example, when the antenna has four branches, a plurality of impedance setting patterns for the four branches are prepared, and the directivity of the antenna is controlled by switching among the setting patterns. An access point is provided with one or more such antennas. In a case of being provided with a plurality of such antennas, a composite radiation pattern may be generated by combining directivities of the antennas. Otherwise, as another configuration, a configuration is also possible in which an antenna is configured by surrounding one antenna element with four metal plates so that a radio wave radiated from the antenna element are reflected by the metal plates and transmitted. In this case, the directivity of the antenna is controlled by adjusting an angle or position of each metal plate. Antenna structures other than those described here are also possible.

The antenna switcher 16 changes the radiation pattern of the variable antenna portion 11 by switching settings for the variable antenna portion 11. The antenna switcher 16 changes the radiation pattern in accordance with an instruction from the communication controller 17.

The interference detector 10 detects interference signals of an operating channel used by the wireless communication device 1 and other channels by analyzing a received signal from the variable antenna portion 11. When an interference signal is detected, a characteristic of the interference signal are grasped. For example, it is identified whether interference with another communication device in the operating channel is interference with a high duty ratio. The operating channel is a channel being used for communication among a plurality of frequency channels set for a frequency domain. The duty ratio is a rate of period during which signals with a level equal to or higher than a threshold have been received, among signals received within a predetermined period. Details of the operation of the interference detector 10 will be described later.

The communication controller 17 performs control related to communication of the wireless communication device 1, control of the radiation pattern of the variable antenna portion 11, channel switching control and the like.

The communication controller 17 performs communication protocol processing as the control related to communication. In the case of a wireless LAN, the communication protocol processing includes MAC layer processing. Specifically, generation of a MAC frame, analysis of a received MAC frame, processing based on an analysis result and the like are included. Processing for an upper layer above the MAC layer (the TCP/IP layer, the UDP/IP layer or the like) may be included. When the kinds of the MAC frames are roughly classified, there are data frame, management frame and control frame, and any of the frames is possible. The data frame is a frame for transmitting data generated inside a wireless communication device to another device. The management frame is a frame used to manage a communication links with other terminals. As examples, a beacon frame, an association request frame, an association response frame and the like are given. The control frame is a frame used to perform control at the time of transmitting/receiving (exchanging) a management frame and a data frame to/from another wireless communication device. As examples, an RTS (Request to Send) frame, a CTS (Clear to Send) frame, an ACK frame and the like are given.

Further, if interference has occurred in the operation channel, the communication controller 17 decides a radiation pattern selection policy according to the state of the interference, as the control of the radiation pattern. As an example, the communication controller 17 selects a policy from among a plurality of policies. The communication controller 17 changes the radiation pattern in accordance with the selected policy.

Further, the communication controller 17 decides to change the operating channel according to the state of the interference. In the case of changing the operating channel, a channel switching signal specifying a channel after change is transmitted. In more detail, a frame which includes the channel switching instruction specifying the channel after change is generated and transmitted. As a specific example of the frame, a beacon frame may be used, or a management frame different from the beacon frame may be used. Transmission of the frame is performed in a procedure in accordance with the CSMA/CA. Accompanying the change of the operating channel, the communication controller 17 changes settings for a transmission filter and a reception filter of the communicator 15.

The storage 14 holds association information (or table information) in which radiation patterns and pieces of antenna setting information are associated. The radiation patterns are given identifiers in advance. Each piece of antenna setting information indicates antenna settings required to obtain a corresponding radiation pattern. For example, each of a plurality of antennas has a plurality of branches, the antenna setting information includes, for each of the plurality of antennas, a value indicating an impedance value (or a resistance value) of each branch. Further, the storage 14 may store information about directivity (a direction, an angle or the like) of each radiation pattern. These pieces of information may be set during manufacture or at the shipment of a product, or the wireless communication device 1 may set the pieces of information in the storage 14 by receiving an instruction to set the pieces of information from an external device. The external device may be a device of a user of the wireless communication device 1 or may be a server.

Further, the storage 14 stores a history of use of radiation patterns by the wireless communication device 1 (hereinafter referred to as a radiation pattern history). As an example, in the radiation pattern history, the number of times of selection, transmission success rate, communication quality and the like of each radiation pattern are stored being classified for each channel. As an example of the communication quality, an RSSI (Received Signal Strength Indicator) and an SN (Signal to Noise) ratio are given. The communication quality may be either an average value or a latest value. In the radiation pattern history, information about time at which and order in which each radiation pattern is used may be stored being classified for each channel. The radiation pattern history is updated by the communication controller 17, by the antenna switcher 16 or by both of them. For example, each time communication is performed, the communication controller 17 updates the radiation pattern history based on a radiation pattern used for the communication, the current channel and a result of the communication.

Here, examples of the policy will be shown. For example, there is a policy for selecting a radiation pattern based on the radiation pattern history stored in the storage 14 (a history use policy). Further, there is a policy for randomly selecting a radiation pattern from among a plurality of radiation patterns which can be set for the variable antenna portion 11 (a random policy). Further, there is a policy for selecting a radiation pattern having directivity in a specified direction or a particular direction (a directivity policy). Further, there is a policy, by switching all the radiation patterns in turn and measuring communication quality (such as the S/N ratio), selecting a radiation pattern from which the highest communication quality or communication quality equal to or higher than a threshold is obtained (an actual measurement policy). The measurement of the communication quality can be performed by the communication controller 17 or the interference detector 10. As an example of other policies, there is a policy for selecting a predetermined radiation pattern or selecting a radiation pattern in predetermined priority order (a prespecified policy). The predetermined radiation pattern may be, for example, the omnidirectional radiation pattern or a radiation pattern other than the omnidirectional radiation pattern.

Each policy may be divided into more detail classifications. For example, the history use policy includes: a policy for selecting a radiation pattern based on the number of times of selection in the past (a number-of-selections policy); a policy for selecting a radiation pattern based on communication success probability (a success rate policy); and a policy for selecting a radiation pattern based on communication quality (a communication quality policy). In addition, there is a policy for selecting a radiation pattern which is not included in the radiation pattern history, and a policy obtained by combining these policies. In the number-of-selections policy, a radiation pattern which has been selected many times may be preferentially selected. In the success rate policy, a radiation pattern with a high success probability may be preferentially selected, or a radiation pattern with a success probability equal to or above a threshold may be preferentially selected. If, in the case of using the history use policy, the radiation pattern history is empty, or a corresponding radiation pattern does not exist, a predetermined default radiation pattern may be selected. As the default radiation pattern, for example, the omnidirectional radiation pattern or a radiation pattern other than the omnidirectional radiation pattern may be used. The policy examples shown here are mere examples, and other various policies can be defined.

Each policy may be stored in the storage 14 or may be stored in the communication controller 17. Each policy may exist in a form of data or may exist in a form of a program (logic).

The communicator 15 performs processing related to the PHY layer (physical layer) of a communication protocol and radio processing. Specifically, as the PHY layer processing, addition of a PHY header to a frame, encoding of the frame, modulation of encoded data and the like at the time of transmission are included. The radio processing includes processing such as DA (Digital to Analog) conversion of a modulated signal, band control by the transmission filter, and up-conversion and amplification of an analog signal. At the time of reception, low-noise amplification of a signal received via an antenna, down-conversion of the amplified signal, band control of the down-converted signal by the reception filter (extraction of a signal of the operating channel) and the like are performed as radio processing. Filter processing for performing band control of the wireless LAN system (extraction of signals of all bands used by the system) may be performed before the down-conversion. The PHY layer processing includes processing such as demodulation and decoding of the band-controlled signal, and analysis (removal) of a physical header.

The functions of the controller 12, the interference detector 10 and the communicator 15 may be performed by software (a program) operating on a processor such as a CPU, or by hardware, or by both of the software and the hardware. The software may be stored in a storage medium such as a memory such as a ROM and a RAM, a hard disk and an SSD, and read and executed by the processor.

The storage 14 may be a memory or may be an SSD, a hard disk or the like. The memory may be a volatile memory such as an SRAM and a DRAM or a nonvolatile memory such as a NAND and an MRAM. Though the storage 14 is shown as an independent block in FIG. 1, it may exist in the antenna switcher 16 or the communication controller 17 or may be distributedly arranged in the antenna switcher 16 and the communication controller 17.

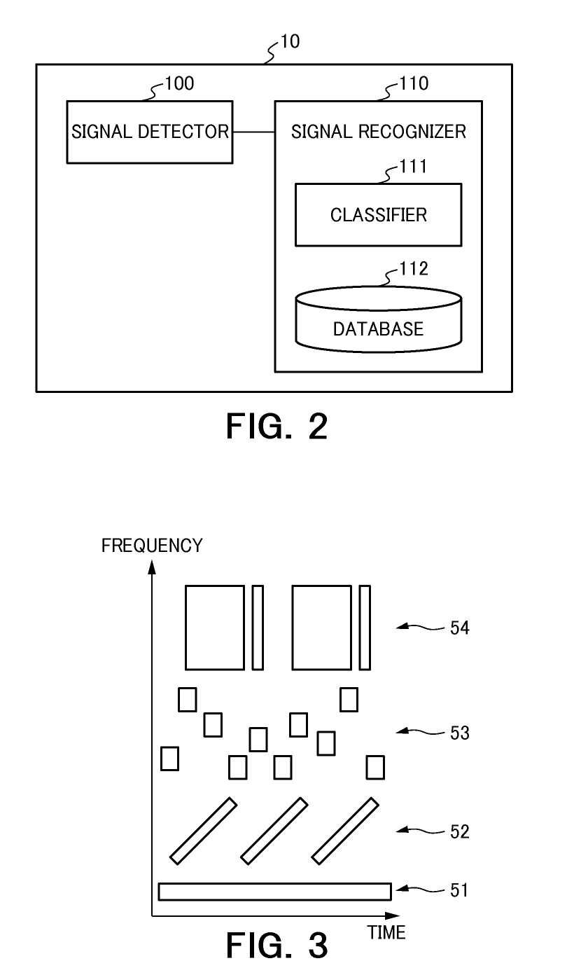

FIG. 2 is a block diagram showing a configuration example of the interference detector 10. The interference detector 10 is provided with a signal detector 100 and a signal recognizer 110.

The signal detector 100 generates data of a relationship between time and frequency (time-frequency data) by a receive signal being inputted from the variable antenna portion 11 and the signal detector 100 analyzing the receive signal. The time-frequency data can be generated, for example, by performing AD conversion and FFT (Fast Fourier Transform) processing of the receive signal. The time-frequency data may be generated in other methods. FIG. 3 shows an example of the time-frequency data. In this example, the time-frequency data includes four waveforms.

A waveform 51 shows that a radio wave with a width of 1 MHz has been continuously received on the low frequency band side. This is a pattern which is seen in a case of output of an analog apparatus such as an analog video recorder, an analog cordless telephone and a jammer (hereinafter, the pattern may be called a continuous wave pattern). A waveform 52 has such a pattern that a frequency cyclically repeats changing at a certain inclination as time progresses, and it is a pattern seen in a case of a radar and the like. In a waveform 53, short pulse-shaped signals randomly appear in a certain frequency band. It is a pattern seen in a case of a Bluetooth® apparatus and the like which perform frequency hopping. In a waveform 54, signals occupying a certain frequency band intermittently appear. It is a pattern seen in a wireless communication device such as a wireless LAN communication device in conformity with IEEE 802.11.

The signal recognizer 110 receives the time-frequency data generated by the signal detector 100 and, by analyzing the time-frequency data, grasps a characteristic of an interference signal existing in a frequency range targeted by analysis. Here, a category of a device which is an interference signal occurrence source (an interference source) is grasped as the characteristic of the interference signal. For this purpose, the signal recognizer 110 is provided with a classifier 111 and a database 112. The analysis may be performed for the whole frequency range targeted by the analysis or may be performed for each of divided bands (channels) obtained by dividing the frequency range into bands corresponding to channels.

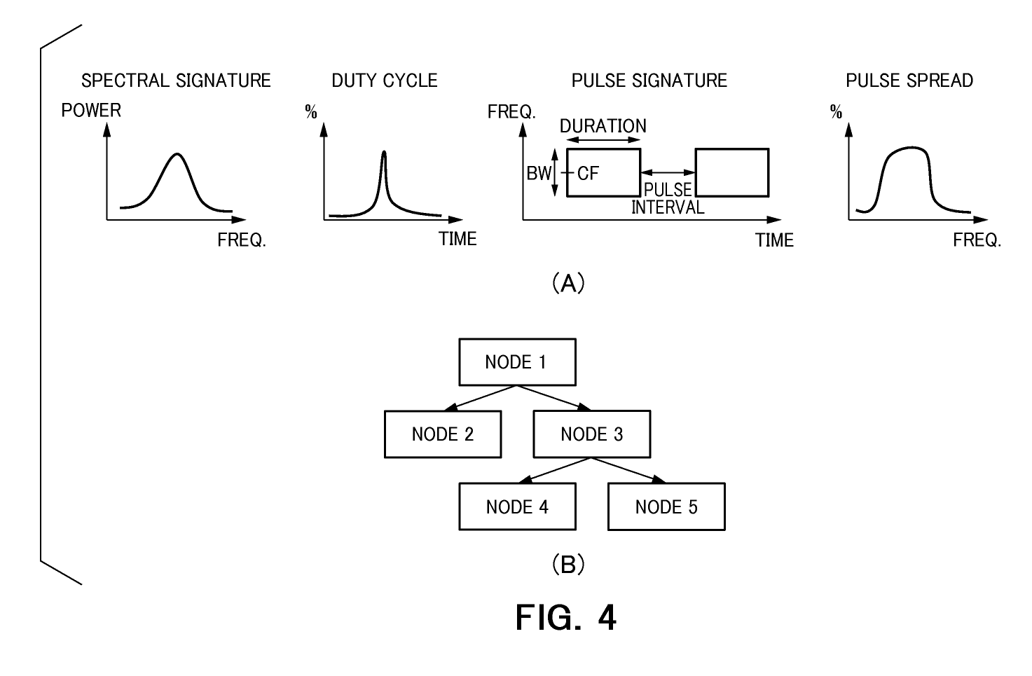

The classifier 111 calculates a plurality of features based on the time-frequency data. As examples of the features, a spectral shape feature, a value or a range showing a rate of time during which a signal is at a high level (a level equal to or higher than a threshold), a pulse shape feature, a degree of pulse spread and the like are given. These features are mere examples, and various features which are effective to judge a device category may be defined. FIG. 4(A) schematically shows the kinds of the features. The classifier 111 identifies the category of the interference-source device based on the plurality of features. As examples of the device category, categories such as analog apparatus (analog video recorder, analog cordless telephone, jammer and the like), Bluetooth apparatus, wireless LAN device (Wi-Fi device), radar device and the like are conceivable. The classifier 111 decides any of these categories as the classification of the interference-source device. Such classification processing can be performed with the use of an arbitrary model. As an example of the model, a binary tree can be used. An example of the binary tree is schematically shown in FIG. 4(B).

The binary tree in FIG. 4(B) is provided with a top node 1, lowest nodes 2, 4 and 5, and an intermediate node 3 other than the top node and the lowest nodes. Processing using one or a plurality of features is assigned to each of the nodes 1 and 3 other than the lowest nodes. The processing is started for the top node 1 and is branched to any lower node (child node) according to a processing result. This is repeated until the lowest nodes are reached. Device categories, which are judgment results, are assigned to the lowest nodes 2, 4 and 5. For example, analog apparatus, Wi-Fi device and radar device are assigned to the node 2, 4 and 5, respectively. The device categories assigned to the reached lowest nodes are decided as the classifications of the interference-source devices.

As an example of processing at the nodes, operation using one or more features is performed, and the processing proceeds to any of a plurality of child nodes according to a result of the operation. For example, it is judged whether a feature or a value obtained by the operation based on the feature is larger than a first value or not, and the processing branches to a first child node if the feature or the value is larger than the first value, and branches to a second child node if the feature or the value is equal to or smaller than the first value. Though the number of child nodes is two in FIG. 4(B), the number may be three or more. The database 112 stores data of the binary tree, a feature calculation formula and the like.

Such a binary tree can be generated by machine learning. For example, signals are received from one or more devices the categories of which are known in advance; a plurality of features are calculated from the received signal, and the calculated plurality of features are accumulated in association with the device categories. By performing machine learning of the data acquired for the plurality of categories of devices, a model for identifying a device category from a plurality of features can be generated.

The model to be used is not limited to a binary tree. Other models such as a neural network are also possible.

Here, an example of identifying a device category has been shown as a method for grasping a characteristic of an interference signal. As another method, it is also possible to prepare a plurality of waveform patterns as templates and identify which waveform pattern an interference signal has. For example, it is also possible to calculate a degree of similarity between waveform data obtained by analyzing a receive signal and each template and identify a waveform pattern with the highest similarity degree. The waveform data may be normalized before calculation of the similarity degree. As for calculation of the similarity degree between waveforms, a general algorithm for calculating a distance between waveforms can be used, and the similarity degree can be determined based on the calculated distance. As an example, the similarity degree may be defined so that the similarity degree becomes a larger value as the distance is smaller. The analysis may be performed for each of divided bands (channels) obtained by dividing the frequency range into bands corresponding to channels.

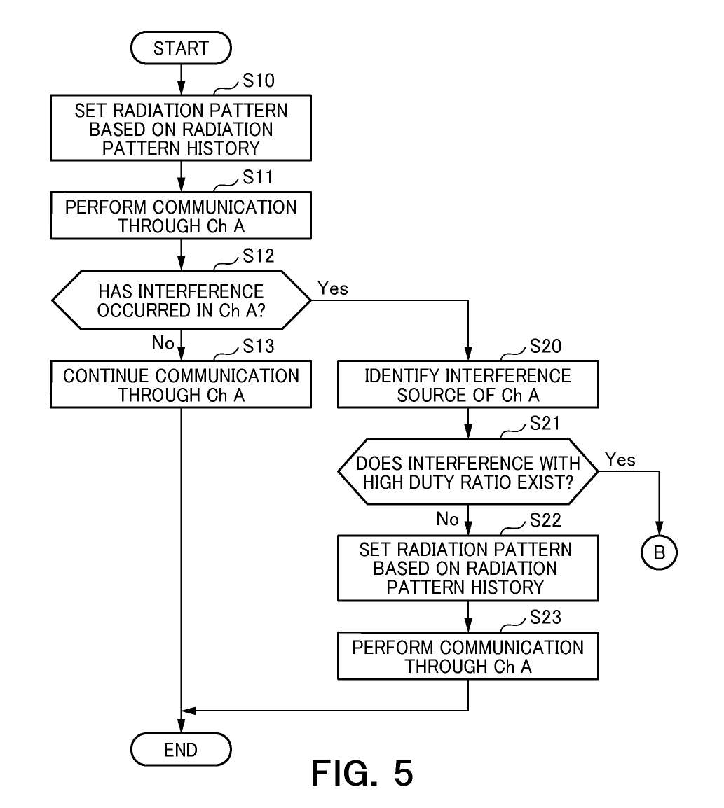

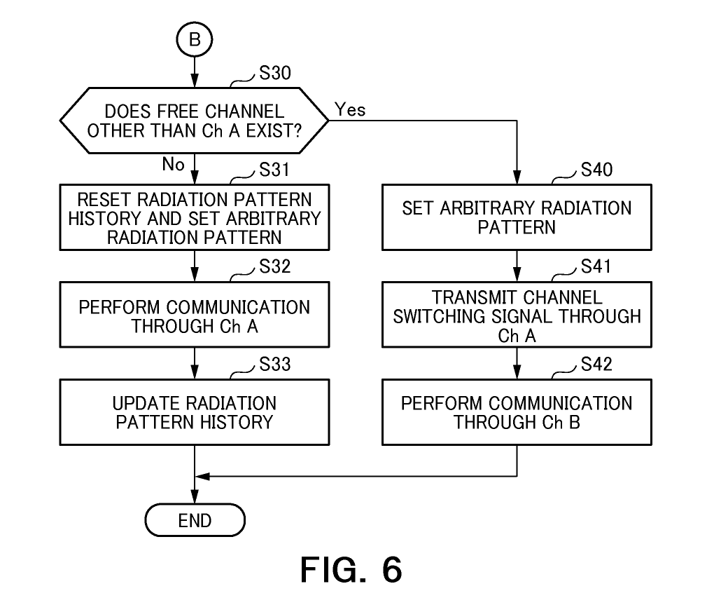

Next, a channel switching process of the wireless communication device 1 according to the present embodiment will be described. FIGS. 5 and 6 are a flowchart of the channel switching process of the wireless communication device 1. In the description below, it is assumed that the wireless communication device 1 uses a channel A as the operating channel.

As shown in FIG. 5, the communication controller 17 selects a radiation pattern in accordance with a predetermined policy and instructs the antenna switcher 16 to set the selected radiation pattern. The antenna switcher 16 sets the variable antenna portion 11 to a configuration corresponding to the radiation pattern (step S10). At step S10, the case of using the history use policy is assumed.

When the radiation pattern is set by the antenna switcher 16, the communication controller 17 performs communication using the channel A via the communicator 15 (step S11). In a case of newly transmitting a frame, the communication controller 17 acquires a right to access a wireless medium in accordance with the CSMA/CA before transmitting the frame. Specifically, the communication controller 17 checks the state of the wireless medium by carrier sensing and, if the state is idle, acquires an access right and performs frame transmission. Further, when receiving a frame which requires an acknowledgement response, from a communication partner terminal, the communication controller 17 transmits an acknowledgement response frame (such as an ACK frame) after a predetermined time after completion of reception of the frame.

The interference detector 10 detects whether radio wave interference with another device has occurred in the channel A, based on a signal received via the variable antenna portion 11 (step S12). For example, the interference detector 10 monitors a wireless medium for a predetermined time, and, if a signal with a level equal to or above a threshold (a signal with such a level that the wireless medium is judged to be in a busy state) from a device outside the network formed by its own device is detected during the time, judges that a radio wave interference has occurred. The detection operation is performed independently from (in parallel to) the communication of the communication controller 17. Whether or not the signal is from a device belonging to the network of its own device can be known, for example, by analyzing the frame or the header of the frame. This analysis may be performed by the interference detector 10, or the communication controller 17 may perform the analysis and notify a result of the analysis to the interference detector 10.

If the interference detector 10 does not detect occurrence of interference (step S12: No), the communication controller 17 maintains the current radiation pattern and continues the communication through the channel A (step S13).

On the other hand, if detecting occurrence of interference in the channel A (step S12: Yes), the interference detector 10 identifies a characteristic of an interference signal in the channel A (step S20). Specifically, the interference detector 10 identifies the device category of an interference source, such as wireless LAN device (Wi-Fi device), analog apparatus (such as analog cordless telephone and analog video recorder), Bluetooth device and radar device. Otherwise, as another method, a waveform pattern may be identified as described above. The case of identifying a device category is assumed below. The number of device categories to be identified is not limited to one but may be more than one. Further, when it is possible to estimate the direction or position of the interference source, or both of them, those may be identified. For the estimation of the direction or position of the interference source, a general arrival direction estimation algorithm or position estimation algorithm can be used. At this time, a process for estimating the arrival direction and the position may be performed by the interference detector 10 or by the communication controller 17.

Next, the interference detector 10 judges whether the duty ratio of the interference source signal is high or not (step S21). The duty ratio is a rate of period during which signals with a level equal to or higher than a threshold have been received, among signals received within a predetermined period. That the duty ratio is high means that the duty ratio is equal to or above a predetermined value.

If a device of a predetermined category defined as a device with a high duty ratio is detected, it is judged that the duty ratio of a signal of the interference source is high. Here, an analog apparatus (such as an analog cordless telephone and an analog video) corresponds to such a device. That is, an analog apparatus is an example of a device with a high duty ratio. In the case of identifying a waveform pattern at step S20, the duty ratio of a signal of the interference source is judged to be high if a waveform in a predetermined pattern, for example, a continuous wave pattern like the waveform 51 in FIG. 3 is detected.

If it is judged that the duty ratio is not high (step S21: No), the interference detector 10 sends information indicating that, though interference has been detected in the channel A, it is not interference with a high duty ratio, to the communication controller 17. When receiving this information, the communication controller 17 decides to change the radiation pattern while deciding to continue the current use of the channel A. The communication controller 17 newly selects a radiation pattern for the channel A based on the current policy (the history use policy). The communication controller 17 outputs an instruction signal to change the radiation pattern to the selected radiation pattern to the antenna switcher 16. The antenna switcher 16 sets the variable antenna portion 11 according to the specified radiation pattern (step S22).

For example, a radiation pattern for which an average of communication quality (such as the SN ratio) is the highest or a radiation pattern with the highest communication success rate is identified. When the identified pattern is the same as the currently used radiation pattern, the current radiation pattern may be maintained, or a radiation pattern with the second highest value may be newly selected. As another example of selection using the radiation pattern history, it is also possible to identify data for which the same radiation pattern as the radiation pattern currently used was used in the past and, if the communication success rate or SN ratio of the identified radiation pattern after switching to the identified radiation pattern is equal to or above a predetermined value, select the same radiation pattern as the identified pattern.

After the radiation pattern of the variable antenna portion is changed, the communication controller 17 performs communication through the channel A via the communicator 15 (step S23). The communication controller 17, the antenna switcher 16, or both of them update the radiation pattern history based on the radiation pattern after the change and a result of the communication (success or failure, or the like).

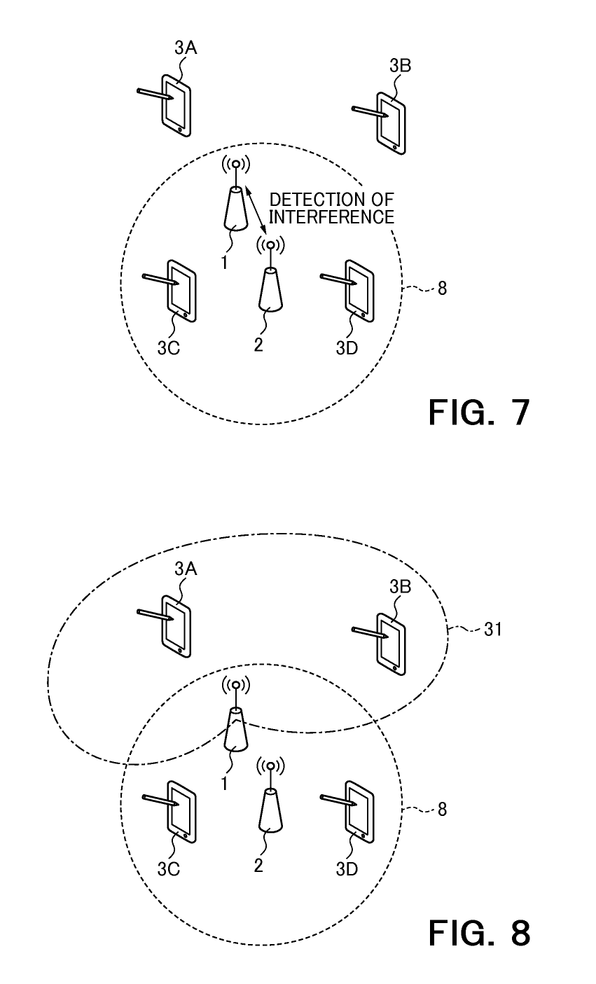

FIG. 7 shows a state in which the operating channel A of the wireless communication device 1 interferes with a radio wave outputted from another communication device 2. In this example, near a wireless LAN system constituted by the wireless communication device 1 corresponding to an access point and terminals 3A, 3B, 3C and 3D, the other communication device 2 of a different system exists. It is assumed that the wireless communication device 1 uses the omnidirectional radiation pattern. It is assumed that the other communication device 2 is a device which outputs a signal with a duty ratio which is not high. Here, the other communication device 2 is assumed to be an adjacent access point or a terminal belonging to the access point. A circular dotted line 8 indicates an area of a radio wave outputted from the other communication device 2. The wireless communication device 1 exists within the area and detects the interference of the channel A.

FIG. 8 is a diagram showing a radiation pattern of the wireless communication device 1 after the other communication device 2 is judged not to be an interference source with a high duty ratio at step S21 in the state of FIG. 7, and the radiation pattern is changed at step S22. A long dashed and short dashed line 31 in FIG. 8 indicates the radiation pattern of the wireless communication device 1. In an area of the radiation pattern, the terminals 3A and 3B are included, but the terminals 3C and 3D and the other communication device 2 are not included. Since the wireless communication device 1 does not receive a radio wave of the other communication device 2 (does not detect a receive signal from the other communication device 2), the wireless communication device 1 can communicate with the terminals 3A and 3B while continuously using the channel A. However, the wireless communication device 1 cannot communicate with the terminals 3C and 3D.

On the other hand, if judging that an interference source with a high duty ratio exists (step S21: Yes), the interference detector 10 sends information notifying that interference has been detected in the channel A, and it is interference with a high duty ratio, to the communication controller 17.

When receiving this information, the communication controller 17 judges whether a free channel exists by checking radio wave reception states of one or more candidate channels other than the channel A (step S30). The judgment about whether a free channel exists can be performed in an arbitrary method. For example, it is possible to monitor a candidate channel for a predetermined time and, if a signal with a predetermined or higher level is not received, judge that the candidate channel is a free channel. Checking on whether a free channel exists or not may be performed by the interference detector 10. In this case, the communication controller 17 outputs an instruction signal to instruct the interference detector 10 to determine whether a free channel exists or not to the interference detector 10, and the interference detector 10 determines whether a free channel exists or not and feeds back a result of the determination.

If judging that there is a free channel among the candidate channels other than the channel A (step S30: Yes), the communication controller 17 decides the detected free channel as a change-destination channel (hereinafter referred to as a channel B) to replace the channel A. The free channel may be a free channel detected earliest. If a plurality of free channels are detected, a channel with the highest communication quality may be selected.

The communication controller 17 changes the policy to the random policy and randomly selects a radiation pattern, that is, selects an arbitrary radiation pattern in accordance with the random policy. The communication controller 17 sets the selected radiation pattern for the variable antenna portion 11 via the antenna switcher 16 (step S40). That is, since it is unknown which radiation pattern can be selected to avoid influence of the interference source and acquire a right to access a wireless medium, a radiation pattern is randomly selected.

After the radiation pattern of the variable antenna portion 11 is changed, the communication controller 17 transmits a channel switching signal through the channel A before changing the operating channel (step S41). In more detail, a frame which includes information specifying channel switching to the channel B is generated, and the frame is transmitted. As an example of the frame instructing channel switching, a beacon frame may be used, or a management frame different from the beacon frame may be used. Transmission of the frame is performed in a procedure in accordance with the CSMA/CA. That is, carrier sensing of a wireless medium is performed; and, if a result of the carrier sensing shows an idle state, the right to access the wireless medium is acquired, and the frame is transmitted. If the channel state is a busy state, and it is not possible to acquire the access right even if a predetermined period elapses, it is also possible to return to step S40 and newly select a radiation pattern under the random policy. Information indicating a timing of performing channel switching may be set for the transmitted frame. The channel switching timing information may be transmitted by a different frame.

The communication controller 17 switches the operating channel from the channel A to the channel B at a predetermined switching timing and, after that, performs communication through the channel B (step S42). A policy used at the time of starting communication through the channel B may be the prespecified policy (for selecting a predetermined radiation pattern or selecting a radiation pattern in predetermined priority order), or the random policy may be continuously used. Other policies may be used. When there is a radiation pattern history of the channel B, the history use policy may be used.

The communication controller 17 may switch the operating channel to the channel B after repeating steps S40 and S41 a plurality of times. Thereby, a possibility of transmitting a channel switching signal in more radiation patterns is strengthened, and a possibility of being able to notify channel switching to as many terminals as possible is strengthened. However, when the number of times is large, a time required before actually changing the channel is longer, and, therefore, it becomes difficult to perform channel change rapidly. Therefore, the number of times of repeating steps S40 and S41 may be restricted depending on a duration allowed before the channel is changed.

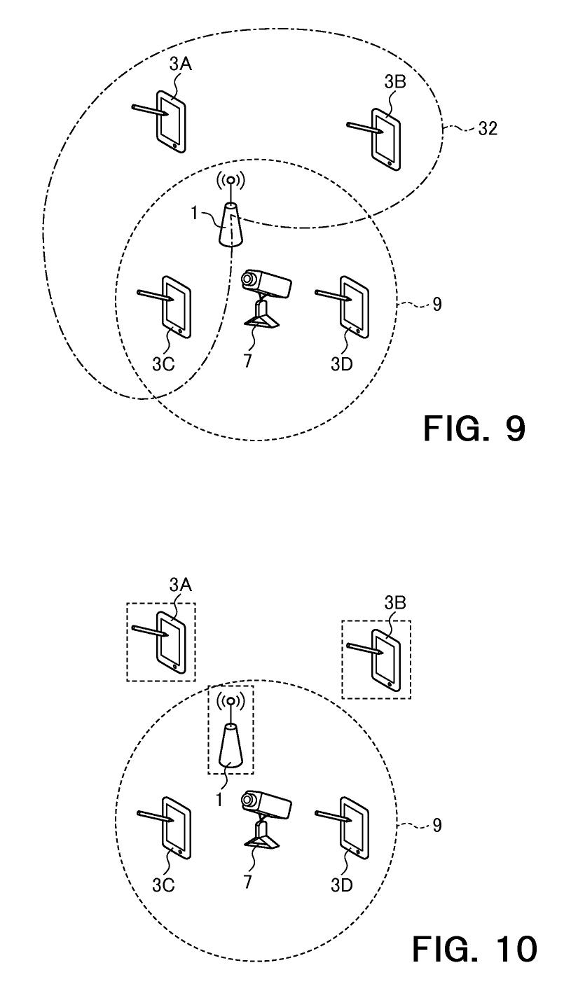

FIG. 9 is a diagram illustrating a specific example of steps S40 and S41. The operating channel A of the wireless communication device 1 interferes with a radio wave outputted from another communication device 7. In this example, near the wireless LAN system constituted by the wireless communication device 1 corresponding to an access point and the terminals 3A, 3B, 3C and 3D, the other communication device 7 of a different system exists. It is assumed that the wireless communication device 1 uses the omnidirectional radiation pattern. It is assumed that the other communication device 7 is a device with a high duty ratio, for example, an analog apparatus such as an analog video camera. A circular dotted line 9 indicates an area of a radio wave outputted from the another communication device 7. The wireless communication device 1 exists within the area and detects the interference of the channel A.

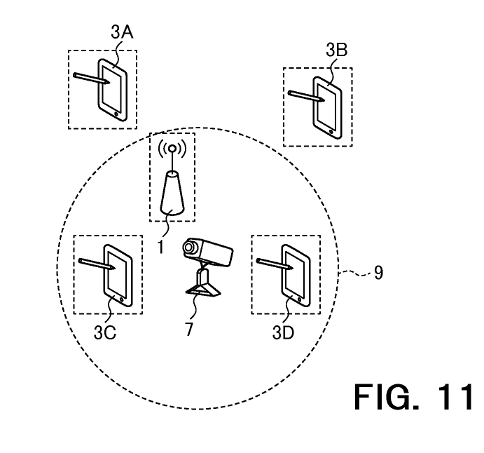

As a result of the wireless communication device 1 having changed the radiation pattern at step S40, a radiation pattern indicated by a long dashed and short dashed line 32 in FIG. 9 is set. The wireless communication device 1 transmits a channel switching signal via the channel A in this radiation pattern. Since the terminals 3A and 3B are included in the area of the radiation pattern and not included in a radio wave area of the other communication device 7, the terminals 3A and 3B succeed in reception of the channel switching signal. Since the terminal 3C is included in the radio wave area of the other communication device 7, whether the terminal 3C succeeds in reception of the channel switching signal depends on directivity of the terminal 3C. Here, it is assumed that the terminal 3C has not succeeded in reception of the channel switching signal. Since the terminal 3D is not included in the radiation pattern of the wireless communication device 1, the terminal 3D does not receive the channel switching signal. For example, the terminals 3A and 3B which have succeeded in reception of the channel switching signal switch operating channels to the channel B, which is a free channel specified by the wireless communication device 1, at a pre-specified timing. FIG. 10 is a diagram showing a state in which the wireless communication device 1 and the terminals 3A and 3B have switched the operating channels from the channel A to the channel B. In FIG. 10, the wireless communication device 1 and the terminals 3A and 3B are surrounded by broken-line rectangles. This means that the operating channels have been switched to the channel B. As for the terminals 3C and 3D, the channel A is still set.

FIG. 11 shows a state in which the terminals 3C and 3D which have detected that it is impossible to communicate with the wireless communication device 1 through the channel A have identified the channel B, which is the operating channel of the wireless communication device 1, by channel search and switched operating channels to the channel B. The terminals 3C and 3D execute an association process with the wireless communication device 1 again through the channel B and belong to the network formed by the wireless communication device 1. Since the operating channels of the terminals 3C and 3D have been switched to the channel B, the terminals 3C and 3D are surrounded by broken-line rectangles in FIG. 11. The wireless communication device 1 and the terminals 3A to 3D can perform communication without interfering with the other communication device 7.

On the other hand, if judging that a free channel does not exist among the candidate channels other than the channel A (step S30: No), the communication controller 17 resets the radiation pattern history stored in the storage 14. Further, the communication controller 17 switches the used policy to the random policy and selects an arbitrary radiation pattern in accordance with the random policy. The communication controller 17 instructs the antenna switcher 16 to change the radiation pattern to the selected radiation pattern, and the antenna switcher 16 sets the specified radiation pattern for the variable antenna portion 11 (step S31). The communication controller 17 performs communication through the channel A (S32). The radiation pattern which has been set, a result of the communication and the like are registered with the radiation pattern history (step S33). Thereby, the radiation pattern history is updated.

Though the history use policy is continuously used to select a radiation pattern at step S22 in FIG. 5, the history use policy may be changed to a different policy. For example, when the number of times that it is judged at step S12 that interference has occurred reaches a predetermined value within a predetermined time, the policy may be changed.

A modification of the process described above will be shown.

### (First Modification)

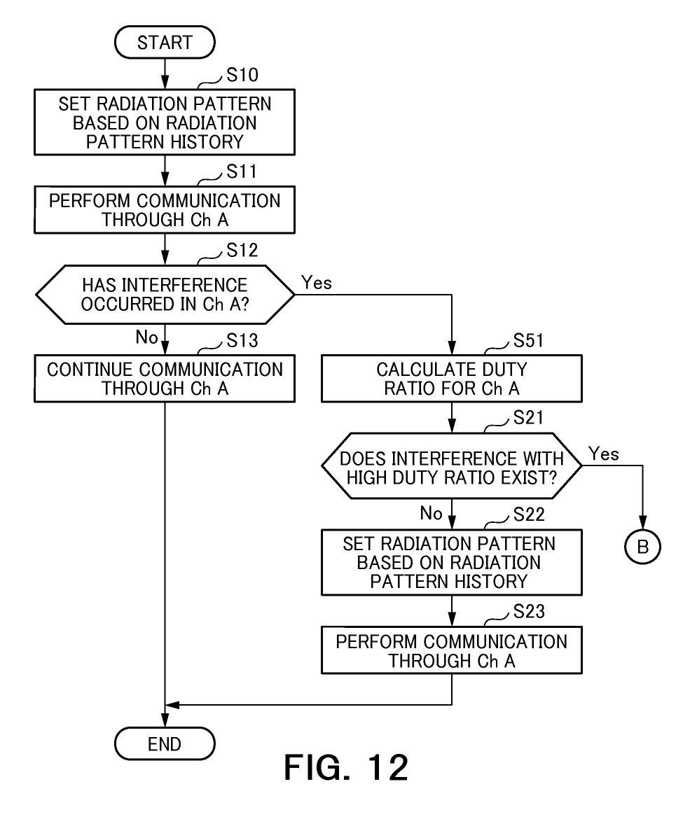

FIG. 12 is a flowchart according to a first modification. Step S20 in FIG. 5 is replaced with step S51. Though a device category is identified at step S20 in FIG. 5, a duty value is calculated at step S51 in the present flow. Specifically, a period during which signals with a level equal to or higher than a threshold have been received, among signals received within a predetermined period is calculated. Then, a rate of the calculated duration to the predetermined duration is calculated. Thereby, a duty ratio is obtained. At the next step S21, it is judged whether or not the duty ratio is equal to or above a predetermined value. If the duty ratio is equal to or above the predetermined value, it is judged that interference with a high duty ratio exists, and the flow proceeds to step S30. If the duty ratio is below the predetermined value, it is judged that interference with a high duty ratio does not exist, and the flow proceeds to step S22. Processes of steps other than steps S30 and S22 may be similar to those described above.

### (Second Modification)

At the time of changing the policy (to the random selection) at step S40 in FIG. 6, a reception judgment threshold (for example, CCA (Clear Channel Assessment) threshold) used in carrier sensing may be increased. As an example, a first threshold is changed to a second threshold larger than the first threshold.

For example, it is assumed that the communicator 15 detects signal reception when receiving a signal with a level equal to or above the first threshold but does not detect signal reception even if receiving a signal with a level below the first threshold. That is, in the case of a signal with a level equal to or above the first threshold, it is judged that a wireless medium is in a busy state, and, in the case of a signal with a level below the first threshold, it is judged that the wireless medium is in an idle state. By increasing the first threshold to the second threshold at step S40, even if a signal with a level equal to or above the first threshold is received, the wireless medium is judged to be in an idle state when the level of the signal is below the second threshold. Therefore, even if a signal is received from the other communication device 7 during carrier sensing, the wireless medium is judged to be idle if the level of the signal is below the second threshold, and it is possible to transmit a channel switching signal. At step S31 in FIG. 6, at step S22 in FIG. 5 or at both of the steps, the reception judgment threshold may be increased at the time of changing the radiation pattern.

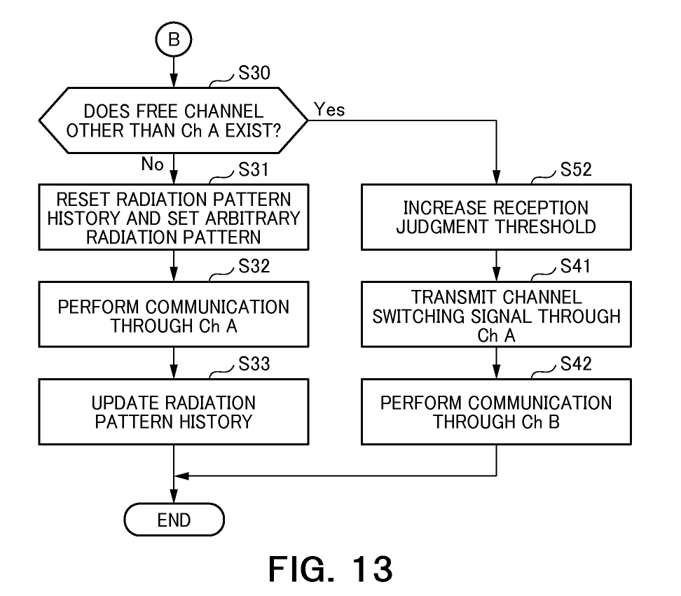

Though the threshold is increased accompanying change of the policy here, the threshold may be increased without changing the policy. A flowchart in this case will be shown in FIG. 13. Step S40 in FIG. 5 is replaced with step S52. At step S52, the reception judgment threshold is increased while the current radiation pattern is maintained. As an example, the first threshold is changed to the second threshold larger than the first threshold. For step S31, for step S22 in FIG. 5 or for both of the steps, the reception judgment threshold may be similarly increased without changing the radiation pattern.

### (Third Modification)

Though the description so far has been made on the assumption that a device which outputs a signal with a high duty is an analog apparatus such as a video camera, there is a possibility that the device is a communication device adopting an LBT scheme other than a wireless LAN communication device. If the possibility exists, it is also possible to select not the random policy but the directivity policy (for selecting a radiation pattern having directivity in a specified direction or a particular direction) as a policy and set such a radiation pattern that the directivity is toward the communication device at step S40. By causing the directivity to be toward the communication device, the communication device can detect a signal transmitted by the wireless communication device 1. The communication device which detects the signal can set a transmission prohibited period (referred to as NAV (Network Allocation Vector) in the case of wireless LAN) to suppress frame transmission. In a case where an access right cannot be acquired by carrier sensing within a predetermined period, however, the policy may be returned to the random policy. At step S40, it is also possible to select a policy other than the random policy and the directivity policy described above.

As described above, according to the present embodiment, when another communication device with a high duty ratio exists, the wireless communication device 1 can rapidly select a radiation pattern capable of preventing interference with the other communication device, by changing the policy. As an example, by changing the history use policy to the random policy, a radiation pattern capable of avoiding interference can be selected rapidly. By transmitting a channel switching signal in a radiation pattern selected in this way, it is possible to notify channel change rapidly. Terminals which receive the channel switching signal can perform channel switching without performing an association process with the wireless communication device 1 again through a channel after the switching. Terminals which cannot receive the channel switching signal (terminals not included in the area of a changed radiation pattern) are required to search for the wireless communication device 1 by channel search and perform an association process but can continuously communicate with the wireless communication device 1 after channel change.

### Second Embodiment

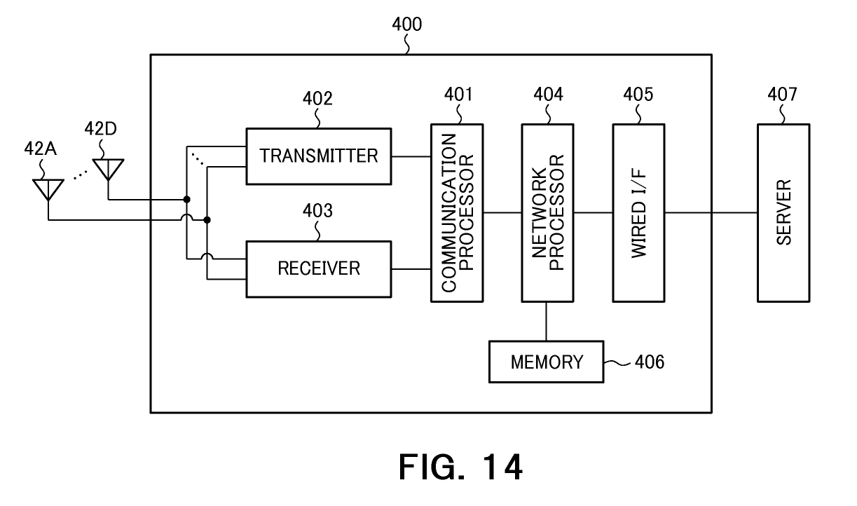

FIG. 14 is a functional block diagram of a base station (access point) 400 according to a second embodiment. The access point includes a communication processor 401, a transmitter 402, a receiver 403, antennas 42A, 42B, 42C, and 42D, a network processor 404, a wired I/F 405, and a memory 406. The access point 400 is connected to a server 407 through the wired I/F 405. The communication processor 401 has functions similar to the controller 12 and the interference detector 10 described in the first embodiment. The transmitter 402 and the receiver 403 have functions similar to the communicator 15 described in the first embodiment. The network processor 404 has functions similar to the higher processor 90 described in the first embodiment. The communication processor 401 may internally possess a buffer for transferring data to and from the network processor 404. The buffer may be a volatile memory, such as an SRAM or a DRAM, or may be a non-volatile memory, such as a NAND or an MRAM.

The network processor 404 controls data exchange with the communication processor 401, data writing and reading to and from the memory 406, and communication with the server 407 through the wired I/F 405. The network processor 404 may execute a higher communication process of the MAC layer, such as TCP/IP or UDP/IP, or a process of the application layer. The operation of the network processor may be performed through processing of software (program) by a processor, such as a CPU. The operation may be performed by hardware or may be performed by both of the software and the hardware.

For example, the communication processor 401 corresponds to a baseband integrated circuit, and the transmitter 402 and the receiver 403 correspond to an RF integrated circuit that transmits and receives frames. The communication processor 401 and the network processor 404 may be formed by one integrated circuit (one chip). Parts that execute processing of digital areas of the transmitter 402 and the receiver 403 and parts that execute processing of analog areas may be formed by different chips. The communication processor 401 may execute a higher communication process of the MAC layer, such as TCP/IP or UDP/IP. Although the number of antennas is four here, it is only necessary that at least one antenna is included.

The memory 406 saves data received from the server 407 and data received by the receiver 402. The memory 406 may be, for example, a volatile memory, such as a DRAM, or may be a non-volatile memory, such as a NAND or an MRAM. The memory 406 may be an SSD, an HDD, an SD card, an eMMC, or the like. The memory 406 may be provided outside of the base station 400.

The wired I/F 405 transmits and receives data to and from the server 407. Although the communication with the server 407 is performed through a wire in the present embodiment, the communication with the server 407 may be performed wirelessly. In this case, a wireless I/F may be employed instead of the wired I/F 405.

The server 407 is a communication device that returns a response including requested data in response to reception of a data forward request for requesting transmission of the data. Examples of the server 407 include an HTTP server (Web server) and an FTP server. However, the server 407 is not limited to these as long as the server 407 has a function of returning the requested data. The server 407 may be a communication device operated by the user, such as a PC or a smartphone.

When the STA belonging to the BSS of the base station 400 issues a forward request of data for the server 407, a packet regarding the data forward request is transmitted to the base station 400. The base station 400 receives the packet through the antennas 42A to 42D. The base station 400 causes the receiver 403 to execute the process of the physical layer and the like and causes the communication processor 401 to execute the process of the MAC layer and the like.

The network processor 404 analyzes the packet received from the communication processor 401. Specifically, the network processor 404 checks the destination IP address, the destination port number, and the like. When the data of the packet is a data forward request such as an HTTP GET request, the network processor 404 checks whether the data requested by the data forward request (for example, data in the URL requested by the HTTP GET request) is cached (stored) in the memory 406. A table associating the URL (or reduced expression of the URL, such as a hash value or an identifier substituting the URL) and the data is stored in the memory 406. The fact that the data is cached in the memory 406 will be expressed that the cache data exists in the memory 406.

When the cache data does not exist in the memory 406, the network processor 404 transmits the data forward request to the server 407 through the wired I/F 405. In other words, the network processor 404 substitutes the STA to transmit the data forward request to the server 407. Specifically, the network processor 404 generates an HTTP request and executes protocol processing, such as adding the TCP/IP header, to transfer the packet to the wired I/F 405. The wired I/F 405 transmits the received packet to the server 407.

The wired I/F 405 receives, from the server 407, a packet that is a response to the data forward request. From the IP header of the packet received through the wired I/F 405, the network processor 404 figures out that the packet is addressed to the STA and transfers the packet to the communication processor 401. The communication processor 401 executes processing of the MAC layer and the like for the packet. The transmitter 402 executes processing of the physical layer and the like and transmits the packet addressed to the STA from the antennas 42A to 42D. The network processor 404 associates the data received from the server 407 with the URL (or reduced expression of the URL) and saves the cache data in the memory 406.

When the cache data exists in the memory 406, the network processor 404 reads the data requested by the data forward request from the memory 406 and transmits the data to the communication processor 401. Specifically, the network processor 404 adds the HTTP header or the like to the data read from the memory 406 and executes protocol processing, such as adding the TCP/IP header, to transmit the packet to the communication processor 401. In this case, the transmitter IP address of the packet is set to the same IP address as the server, and the transmitter port number is also set to the same port number as the server (destination port number of the packet transmitted by the communication terminal), for example. Therefore, it can be viewed from the STA as if communication with the server 407 is established. The communication processor 401 executes processing of the MAC layer and the like for the packet. The transmitter 402 executes processing of the physical layer and the like and transmits the packet addressed to the STA from the antennas 42A to 42D.

According to the operation, frequently accessed data is responded based on the cache data saved in the memory 406, and the traffic between the server 407 and the base station 400 can be reduced. Note that the operation of the network processor 404 is not limited to the operation of the present embodiment. There is no problem in performing other operation when a general caching proxy is used, in which data is acquired from the server 407 in place of the STA, the data is cached in the memory 406, and a response is made from the cache data of the memory 406 for a data forward request of the same data.

The base station (access point) according to the present invention can be applied for the base station in the first embodiment. The transmission of the frame, the data or the packet used in first embodiment may be carried out based on the cached data stored in the memory 406. Also, information obtained based on the frame, the data or the packet received by the base station in first embodiment may be cached in the memory 406. The frame transmitted by the base station in the first embodiment may include the cached data or information based on the cached data. The information based on the cached data may include information on existence or non-existence of data addressed to the terminal, information on a size of the data, a size of a packet required for transmission of the data. The information based on the cached data may include a modulation scheme required for transmission of the data.

In the present embodiment, although the base station with the cache function is described, a terminal (STA) with the cache function can also be realized by the same block configuration as FIG. 14. The terminal means non-base station terminal (as stated above, the base station is one form of the wireless communication terminal). In this case, the wired I/F 405 may be omitted. The transmission, by the terminal, of the frame, the data or the packet used in first embodiment may be carried out based on the cached data stored in the memory 406. Also, information obtained based on the frame, the data or the packet received by the terminal in first embodiment may be cached in the memory 406. The frame transmitted by the terminal in the first embodiment may include the cached data or information based on the cached data. The information based on the cached data may include information on existence or non-existence of data addressed to the terminal, information on a size of the data, a size of a packet required for transmission of the data. The information based on the cached data may include a modulation scheme required for transmission of the data.

### Third Embodiment

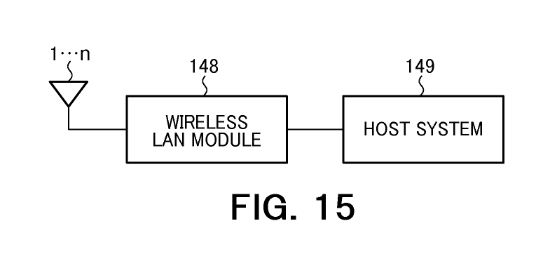

FIG. 15 shows an example of entire configuration of a terminal or a base station. The example of configuration is just an example, and the present embodiment is not limited to this. The terminal or the base station includes one or a plurality of antennas 1 to n (n is an integer equal to or greater than 1), a wireless LAN module 148, and a host system 149. The wireless LAN module 148 corresponds to the wireless communication device according to the first embodiment. The wireless LAN module 148 includes a host interface and is connected to the host system 149 through the host interface. Other than the connection to the host system 149 through the connection cable, the wireless LAN module 148 may be directly connected to the host system 149. The wireless LAN module 148 can be mounted on a substrate by soldering or the like and can be connected to the host system 149 through wiring of the substrate. The host system 149 uses the wireless LAN module 148 and the antennas 1 to n to communicate with external apparatuses according to an arbitrary communication protocol. The communication protocol may include the TCP/IP and a protocol of a layer higher than that. Alternatively, the TCP/IP may be mounted on the wireless LAN module 148, and the host system 149 may execute only a protocol in a layer higher than that. In this case, the configuration of the host system 149 can be simplified. Examples of the present terminal include a mobile terminal, a TV, a digital camera, a wearable device, a tablet, a smartphone, a game device, a network storage device, a monitor, a digital audio player, a Web camera, a video camera, a projector, a navigation system, an external adaptor, an internal adaptor, a set top box, a gateway, a printer server, a mobile access point, a router, an enterprise/service provider access point, a portable device, a hand-held device, a vehicle and so on.

The wireless LAN module 148 (or the wireless communication device) may have functions of other wireless communication standards such as LTE (Long Term Evolution), LTE-Advanced (standards for mobile phones) as well as the IEEE802.11.

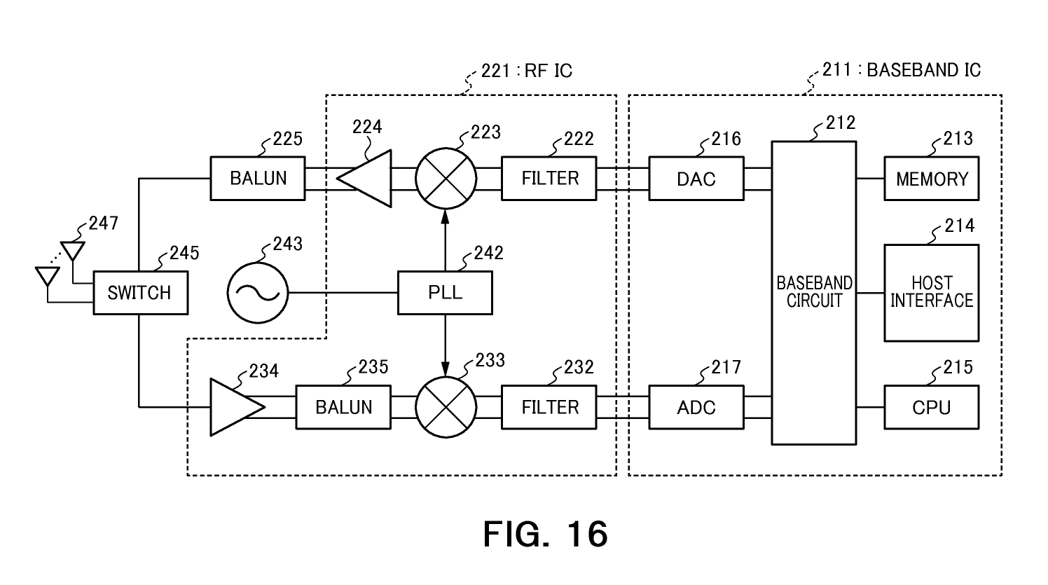

FIG. 16 shows an example of hardware configuration of a wireless LAN module. The configuration can also be applied when the wireless communication device is mounted on either one of the terminal that is a non-base station and the base station. Therefore, the configuration can be applied as an example of specific configuration of the wireless communication device shown in FIG. 1. At least one antenna 247 is included in the example of configuration. When a plurality of antennas are included, a plurality of sets of a transmission system (216 and 222 to 225), a reception system (217, 232 to 235), a PLL 242, a crystal oscillator (reference signal source) 243, and a switch 245 may be arranged according to the antennas, and each set may be connected to a control circuit 212. One or both of the PLL 242 and the crystal oscillator 243 correspond to an oscillator according to the present embodiment.

The wireless LAN module (wireless communication device) includes a baseband IC (Integrated Circuit) 211, an RF (Radio Frequency) IC 221, a balun 225, the switch 245, and the antenna 247.

The baseband IC 211 includes the baseband circuit (control circuit) 212, a memory 213, a host interface 214, a CPU 215, a DAC (Digital to Analog Converter) 216, and an ADC (Analog to Digital Converter) 217.

The baseband IC 211 and the RF IC 221 may be formed on the same substrate. The baseband IC 211 and the RF IC 221 may be formed by one chip. Both or one of the DAC 216 and the ADC 217 may be arranged on the RF IC 221 or may be arranged on another IC. Both or one of the memory 213 and the CPU 215 may be arranged on an IC other than the baseband IC.

The memory 213 stores data to be transferred to and from the host system. The memory 213 also stores one or both of information to be transmitted to the terminal or the base station and information transmitted from the terminal or the base station. The memory 213 may also store a program necessary for the execution of the CPU 215 and may be used as a work area for the CPU 215 to execute the program. The memory 213 may be a volatile memory, such as an SRAM or a DRAM, or may be a non-volatile memory, such as a NAND or an MRAM.

The host interface 214 is an interface for connection to the host system. The interface can be anything, such as UART, SPI, SDIO, USB, or PCI Express.

The CPU 215 is a processor that executes a program to control the baseband circuit 212. The baseband circuit 212 mainly executes a process of the MAC layer and a process of the physical layer. One or both of the baseband circuit 212 and the CPU 215 correspond to the communication control apparatus that controls communication, the controller that controls communication, or controlling circuitry that controls communication.

At least one of the baseband circuit 212 or the CPU 215 may include a clock generator that generates a clock and may manage internal time by the clock generated by the clock generator.

For the process of the physical layer, the baseband circuit 212 performs addition of the physical header, coding, encryption, modulation process, and the like of the frame to be transmitted and generates, for example, two types of digital baseband signals (hereinafter, “digital I signal” and “digital Q signal”).

The DAC 216 performs DA conversion of signals input from the baseband circuit 212. More specifically, the DAC 216 converts the digital I signal to an analog I signal and converts the digital Q signal to an analog Q signal. Note that a single system signal may be transmitted without performing quadrature modulation. When a plurality of antennas are included, and single system or multi-system transmission signals equivalent to the number of antennas are to be distributed and transmitted, the number of provided DACs and the like may correspond to the number of antennas.

The RF IC 221 is, for example, one or both of an RF analog IC and a high frequency IC. The RF IC 221 includes a filter 222, a mixer 223, a preamplifier (PA) 224, the PLL (Phase Locked Loop) 242, a low noise amplifier (LNA) 234, a balun 235, a mixer 233, and a filter 232. Some of the elements may be arranged on the baseband IC 211 or another IC. The filters 222 and 232 may be bandpass filters or low pass filters. The RF IC 221 is connected to the antenna 247 through the switch 245.

The filter 222 extracts a signal of a desired band from each of the analog I signal and the analog Q signal input from the DAC 216. The PLL 242 uses an oscillation signal input from the crystal oscillator 243 and performs one or both of division and multiplication of the oscillation signal to thereby generate a signal at a certain frequency synchronized with the phase of the input signal. Note that the PLL 242 includes a VCO (Voltage Controlled Oscillator) and uses the VCO to perform feedback control based on the oscillation signal input from the crystal oscillator 243 to thereby obtain the signal at the certain frequency. The generated signal at the certain frequency is input to the mixer 223 and the mixer 233. The PLL 242 is equivalent to an example of an oscillator that generates a signal at a certain frequency.

The mixer 223 uses the signal at the certain frequency supplied from the PLL 242 to up-convert the analog I signal and the analog Q signal passed through the filter 222 into a radio frequency. The preamplifier (PA) amplifies the analog I signal and the analog Q signal at the radio frequency generated by the mixer 223, up to desired output power. The balun 225 is a converter for converting a balanced signal (differential signal) to an unbalanced signal (single-ended signal). Although the balanced signal is handled by the RF IC 221, the unbalanced signal is handled from the output of the RF IC 221 to the antenna 247. Therefore, the balun 225 performs the signal conversions.

The switch 245 is connected to the balun 225 on the transmission side during the transmission and is connected to the LNA 234 or the RF IC 221 on the reception side during the reception. The baseband IC 211 or the RF IC 221 may control the switch 245. There may be another circuit that controls the switch 245, and the circuit may control the switch 245.

The analog I signal and the analog Q signal at the radio frequency amplified by the preamplifier 224 are subjected to balanced-unbalanced conversion by the balun 225 and are then emitted as radio waves to the space from the antenna 247.

The antenna 247 may be a chip antenna, may be an antenna formed by wiring on a printed circuit board, or may be an antenna formed by using a linear conductive element.

The LNA 234 in the RF IC 221 amplifies a signal received from the antenna 247 through the switch 245 up to a level that allows demodulation, while maintaining the noise low. The balun 235 performs unbalanced-balanced conversion of the signal amplified by the low noise amplifier (LNA) 234. The mixer 233 uses the signal at the certain frequency input from the PLL 242 to down-convert, to a baseband, the reception signal converted to a balanced signal by the balun 235. More specifically, the mixer 233 includes a unit that generates carrier waves shifted by a phase of 90 degrees based on the signal at the certain frequency input from the PLL 242. The mixer 233 uses the carrier waves shifted by a phase of 90 degrees to perform quadrature demodulation of the reception signal converted by the balun 235 and generates an I (In-phase) signal with the same phase as the reception signal and a Q (Quad-phase) signal with the phase delayed by 90 degrees. The filter 232 extracts signals with desired frequency components from the I signal and the Q signal. Gains of the I signal and the Q signal extracted by the filter 232 are adjusted, and the I signal and the Q signal are output from the RF IC 221.

The ADC 217 in the baseband IC 211 performs AD conversion of the input signal from the RF IC 221. More specifically, the ADC 217 converts the I signal to a digital I signal and converts the Q signal to a digital Q signal. Note that a single system signal may be received without performing quadrature demodulation.

When a plurality of antennas are provided, the number of provided ADCs may correspond to the number of antennas. Based on the digital I signal and the digital Q signal, the baseband circuit 212 executes a process of the physical layer and the like, such as demodulation process, error correcting code process, and process of physical header, and obtains a frame. The baseband circuit 212 applies a process of the MAC layer to the frame. Note that the baseband circuit 212 may be configured to execute a process of TCP/IP when the TCP/IP is implemented.

The baseband circuit 212 or the host interface 214 may change an operation channel by switching setting of the filter 222 and filter 232. The baseband circuit 212 or the host interface 214 may change the radiation patter of the antenna 247 by changing the setting of the antenna 247. The baseband circuit 212 may include functions of the interference detector 10 and the controller 12.

### Fourth Embodiment

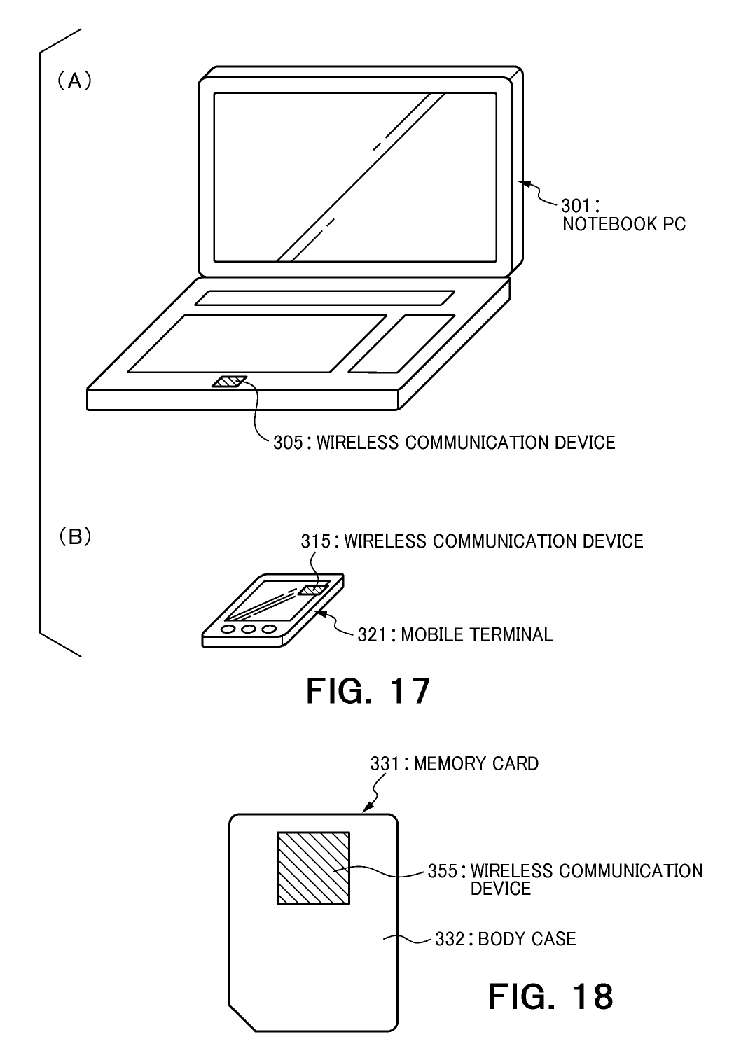

FIG. 17(A) and FIG. 17(B) are perspective views of wireless terminal according to the fourth embodiment. The wireless terminal in FIG. 17(A) is a notebook PC 301 and the wireless communication device (or a wireless device) in FIG. 17(B) is a mobile terminal 321. Each of them corresponds to one form of a terminal (which may indicate a base station). The notebook PC 301 and the mobile terminal 321 are equipped with wireless communication devices 305 and 315, respectively. The wireless communication device provided in a terminal (which may indicate a base station) which has been described above can be used as the wireless communication devices 305 and 315. A wireless terminal carrying a wireless communication device is not limited to notebook PCs and mobile terminals. For example, it can be installed in a TV, a digital camera, a wearable device, a tablet, a smart phone, a gaming device, a network storage device, a monitor, a digital audio player, a web camera, a video camera, a projector, a navigation system, an external adapter, an internal adapter, a set top box, a gateway, a printer server, a mobile access point, a router, an enterprise/service provider access point, a portable device, a handheld device and a vehicle and so on.

Moreover, a wireless communication device installed in a terminal (which may indicate a base station) can also be provided in a memory card. FIG. 18 illustrates an example of a wireless communication device mounted on a memory card. A memory card 331 contains a wireless communication device 355 and a body case 332. The memory card 331 uses the wireless communication device 355 for wireless communication with external devices. Here, in FIG. 18, the description of other installed elements (for example, a memory, and so on) in the memory card 331 is omitted.

### Fifth Embodiment

In the fifth embodiment, a bus, a processor unit and an external interface unit are provided in addition to the configuration of the wireless communication device according to any of the above embodiments. The processor unit and the external interface unit are connected with an external memory (a buffer) through the bus. A firmware operates the processor unit. Thus, by adopting a configuration in which the firmware is included in the wireless communication device, the functions of the wireless communication device can be easily changed by rewriting the firmware. The processing unit in which the firmware operates may be a processor that performs the process of the communication controlling device or the control unit according to the present embodiment, or may be another processor that performs a process relating to extending or altering the functions of the process of the communication controlling device or the control unit. The processing unit in which the firmware operates may be included in the access point or the wireless terminal according to the present embodiment. Alternatively, the processing unit may be included in the integrated circuit of the wireless communication device installed in the access point, or in the integrated circuit of the wireless communication device installed in the wireless terminal.

### Sixth Embodiment

In the sixth embodiment, a clock generating unit is provided in addition to the configuration of the wireless communication device according to any of the above embodiments. The clock generating unit generates a clock and outputs the clock from an output terminal to the exterior of the wireless communication device. Thus, by outputting to the exterior the clock generated inside the wireless communication device and operating the host by the clock output to the exterior, it is possible to operate the host and the wireless communication device in a synchronized manner.

### Seventh Embodiment

In the seventh embodiment, a power source unit, a power source controlling unit and a wireless power feeding unit are included in addition to the configuration of the wireless communication device according to any of the above embodiments. The power supply controlling unit is connected to the power source unit and to the wireless power feeding unit, and performs control to select a power source to be supplied to the wireless communication device. Thus, by adopting a configuration in which the power source is included in the wireless communication device, power consumption reduction operations that control the power source are possible.

### Eighth Embodiment

In the eighth embodiment, a SIM card is added to the configuration of the wireless communication device according to the above embodiments. For example, the SIM card is connected with at least any one of blocks in the wireless communication device in FIG. 1. Thus, by adopting a configuration in which the SIM card is included in the wireless communication device, authentication processing can be easily performed.

### Ninth Embodiment

In the ninth embodiment, a video image compressing/decompressing unit is added to the configuration of the wireless communication device according to any of the above embodiments. The video image compressing/decompressing unit is connected to the bus. Thus, by adopting a configuration in which the video image compressing/decompressing unit is included in the wireless communication device, transmitting a compressed video image and decompressing a received compressed video image can be easily done.

### Tenth Embodiment

In the tenth embodiment, an LED unit is added to the configuration of the wireless communication device according to any of the above embodiments. For example, the LED unit is connected at least any one of blocks in the wireless communication device in FIG. 1. Thus, by adopting a configuration in which the LED unit is included in the wireless communication device, notifying the operation state of the wireless communication device to the user can be easily done.

### Eleventh Embodiment

In the eleventh embodiment, a vibrator unit is included in addition to the configuration of the wireless communication device according to any of the above embodiments. For example, the vibrator unit is connected at least any one of blocks in the wireless communication device in FIG. 1. Thus, by adopting a configuration in which the vibrator unit is included in the wireless communication device, notifying the operation state of the wireless communication device to the user can be easily done.

### Twelfth Embodiment

In the present embodiment, [1] the frame type in the wireless communication system, [2] a technique of disconnection between wireless communication devices, [3] an access scheme of a wireless LAN system and [4] a frame interval of a wireless LAN are described.

### [1] Frame Type in Communication System

Generally, as mentioned above, frames treated on a wireless access protocol in a wireless communication system are roughly divided into three types of the data frame, the management frame and the control frame. These types are normally shown in a header part which is commonly provided to frames. As a display method of the frame type, three types may be distinguished in one field or may be distinguished by a combination of two fields. In IEEE 802.11 standard, identification of a frame type is made based on two fields of Type and Subtype in the Frame Control field in the header part of the MAC frame. The Type field is one for generally classifying frames into a data frame, a management frame, or a control frame and the Subtype field is one for identifying more detailed type in each of the classified frame types such as a beacon frame belonging to the management frame.

The management frame is a frame used to manage a physical communication link with a different wireless communication device. For example, there are a frame used to perform communication setting with the different wireless communication device or a frame to release communication link (that is, to disconnect the connection), and a frame related to the power save operation in the wireless communication device.

The data frame is a frame to transmit data generated in the wireless communication device to the different wireless communication device after a physical communication link with the different wireless communication device is established. The data is generated in a higher layer of the present embodiment and generated by, for example, a user's operation.

The control frame is a frame used to perform control at the time of transmission and reception (exchange) of the data frame with the different wireless communication device. A response frame transmitted for the acknowledgment in a case where the wireless communication device receives the data frame or the management frame, belongs to the control frame. The response frame is, for example, an ACK frame or a BlockACK frame. The RTS frame and the CTS frame are also the control frame.

These three types of frames are subjected to processing based on the necessity in the physical layer and then transmitted as physical packets via an antenna. In IEEE 802.11 standard (including the extended standard such as IEEE Std 802.11ac-2013), an association process is defined as one procedure for connection establishment. The association request frame and the association response frame which are used in the procedure are a management frame. Since the association request frame and the association response frame is the management frame transmitted in a unicast scheme, the frames causes the wireless communication terminal in the receiving side to transmit an ACK frame being a response frame. The ACK frame is a control frame as described in the above.

### [2] Technique of Disconnection Between Wireless Communication Devices

For disconnection of the connection (release), there are an explicit technique and an implicit technique. As the explicit technique, a frame to disconnect any one of the connected wireless communication devices is transmitted. This frame corresponds to Deauthentication frame defined in IEEE 802.11 standard and is classified into the management frame. Normally, it is determined that the connection is disconnected at the timing of transmitting the frame to disconnect the connection in a wireless communication device on the side to transmit the frame and at the timing of receiving the frame to disconnect the connection in a wireless communication device on the side to receive the frame. Afterward, it returns to the initial state in a communication phase, for example, a state to search for a wireless communication device of the communicating partner. In a case that the wireless communication base station disconnects with a wireless communication terminal, for example, the base station deletes information on the wireless communication device from a connection management table if the base station holds the connection management table for managing wireless communication terminals which entries into the BSS of the base station-self. For example, in a case that the base station assigns an AID to each wireless communication terminal which entries into the BSS at the time when the base station permitted each wireless communication terminal to connect to the base station-self in the association process, the base station deletes the held information related to the AID of the wireless communication terminal disconnected with the base station and may release the AID to assign it to another wireless communication device which newly entries into the BSS.

On the other hand, as the implicit technique, it is determined that the connection state is disconnected in a case where frame transmission (transmission of a data frame and management frame or transmission of a response frame with respect to a frame transmitted by the subject device) is not detected from a wireless communication device of the connection partner which has established the connection for a certain period. Such a technique is provided because, in a state where it is determined that the connection is disconnected as mentioned above, a state is considered where the physical wireless link cannot be secured, for example, the communication distance to the wireless communication device of the connection destination is separated and the radio signals cannot be received or decoded. That is, it is because the reception of the frame to disconnect the connection cannot be expected.

As a specific example to determine the disconnection of connection in an implicit method, a timer is used. For example, at the time of transmitting a data frame that requests an acknowledgment response frame, a first timer (for example, a retransmission timer for a data frame) that limits the retransmission period of the frame is activated, and, if the acknowledgement response frame to the frame is not received until the expiration of the first timer (that is, until a desired retransmission period passes), retransmission is performed. When the acknowledgment response frame to the frame is received, the first timer is stopped.

On the other hand, when the acknowledgment response frame is not received and the first timer expires, for example, a management frame to confirm whether a wireless communication device of a connection partner is still present (in a communication range) (in other words, whether a wireless link is secured) is transmitted, and, at the same time, a second timer (for example, a retransmission timer for the management frame) to limit the retransmission period of the frame is activated. Similarly to the first timer, even in the second timer, retransmission is performed if an acknowledgment response frame to the frame is not received until the second timer expires, and it is determined that the connection is disconnected when the second timer expires.

Alternatively, a third timer is activated when a frame is received from a wireless communication device of the connection partner, the third timer is stopped every time the frame is newly received from the wireless communication device of the connection partner, and it is activated from the initial value again. When the third timer expires, similarly to the above, a management frame to confirm whether the wireless communication device of the connection party is still present (in a communication range) (in other words, whether a wireless link is secured) is transmitted, and, at the same time, a second timer (for example, a retransmission timer for the management frame) to limit the retransmission period of the frame is activated. Even in this case, retransmission is performed if an acknowledgment response frame to the frame is not received until the second timer expires, and it is determined that the connection is disconnected when the second timer expires. The latter management frame to confirm whether the wireless communication device of the connection partner is still present may differ from the management frame in the former case. Moreover, regarding the timer to limit the retransmission of the management frame in the latter case, although the same one as that in the former case is used as the second timer, a different timer may be used.

### [3] Access Scheme of Wireless LAN System

For example, there is a wireless LAN system with an assumption of communication or competition with a plurality of wireless communication devices. CSMA/CA is set as the basis of an access scheme in IEEE802.11 (including an extension standard or the like) wireless LAN. In a scheme in which transmission by a certain wireless communication device is grasped and transmission is performed after a fixed time from the transmission end, simultaneous transmission is performed in the plurality of wireless communication devices that grasp the transmission by the wireless communication device, and, as a result, radio signals collide and frame transmission fails. By grasping the transmission by the certain wireless communication device and waiting for a random time from the transmission end, transmission by the plurality of wireless communication devices that grasp the transmission by the wireless communication device stochastically disperses. Therefore, if the number of wireless communication devices in which the earliest time in a random time is subtracted is one, frame transmission by the wireless communication device succeeds and it is possible to prevent frame collision. Since the acquisition of the transmission right based on the random value becomes impartial between the plurality of wireless communication devices, it can say that a scheme adopting Carrier Avoidance is a suitable scheme to share a radio medium between the plurality of wireless communication devices.

### [4] Frame Interval of Wireless LAN

The frame interval of IEEE802.11 wireless LAN is described. There are various types of frame intervals used in IEEE802.11 wireless LAN, such as distributed coordination function interframe space (DIFS), arbitration interframe space (AIFS), point coordination function interframe space (PIFS), short interframe space (SIFS), extended interframe space (EIFS) and reduced interframe space (RIFS).

The definition of the frame interval is defined as a continuous period that should confirm and open the carrier sensing idle before transmission in IEEE802.11 wireless LAN, and a strict period from a previous frame is not discussed. Therefore, the definition is followed in the explanation of IEEE802.11 wireless LAN system. In IEEE802.11 wireless LAN, a waiting time at the time of random access based on CSMA/CA is assumed to be the sum of a fixed time and a random time, and it can say that such a definition is made to clarify the fixed time.

DIFS and AIFS are frame intervals used when trying the frame exchange start in a contention period that competes with other wireless communication devices on the basis of CSMA/CA. DIFS is used in a case where priority according to the traffic type is not distinguished, AIFS is used in a case where priority by traffic identifier (TID) is provided.

Since operation is similar between DIFS and AIFS, an explanation below will mainly use AIFS. In IEEE802.11 wireless LAN, access control including the start of frame exchange in the MAC layer is performed. In addition, in a case where QoS (Quality of Service) is supported when data is transferred from a higher layer, the traffic type is notified together with the data, and the data is classified for the priority at the time of access on the basis of the traffic type. The class at the time of this access is referred to as “access category (AC)”. Therefore, the value of AIFS is provided every access category.

PIFS denotes a frame interval to enable access which is more preferential than other competing wireless communication devices, and the period is shorter than the values of DIFS and AIFS. SIFS denotes a frame interval which can be used in a case where frame exchange continues in a burst manner at the time of transmission of a control frame of a response system or after the access right is acquired once. EIFS denotes a frame interval caused when frame reception fails (when the received frame is determined to be error).

RIFS denotes a frame interval which can be used in a case where a plurality of frames are consecutively transmitted to the same wireless communication device in a burst manner after the access right is acquired once, and a response frame from a wireless communication device of the transmission partner is not requested while RIFS is used.

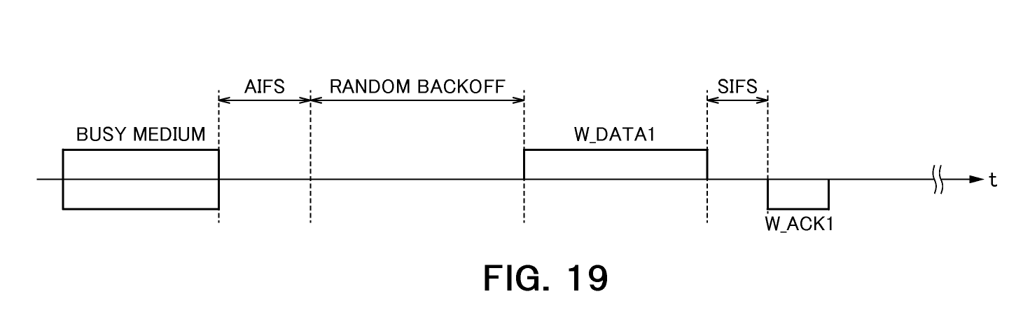

Here, FIG. 19 illustrates one example of frame exchange in a competitive period based on the random access in IEEE802.11 wireless LAN.

When a transmission request of a data frame (W_DATA1) is generated in a certain wireless communication device, a case is assumed where it is recognized that a medium is busy (busy medium) as a result of carrier sensing. In this case, AIFS of a fixed time is set from the time point at which the carrier sensing becomes idle, and, when a random time (random backoff) is set afterward, data frame W_DATA1 is transmitted to the communicating partner.

The random time is acquired by multiplying a slot time by a pseudorandom integer led from uniform distribution between contention windows (CW) given by integers from 0. Here, what multiplies CW by the slot time is referred to as “CW time width”. The initial value of CW is given by CWmin, and the value of CW is increased up to CWmax every retransmission. Similarly to AIFS, both CWmin and CWmax have values every access category. In a wireless communication device of transmission destination of W_DATA1, when reception of the data frame succeeds, a response frame (W_ACK1) is transmitted after SIFS from the reception end time point. If it is within a transmission burst time limit when W_ACK1 is received, the wireless communication device that transmits W_DATA1 can transmit the next frame (for example, W_DATA2) after SIFS.

Although AIFS, DIFS, PIFS and EIFS are functions between SIFS and the slot-time, SIFS and the slot time are defined every physical layer. Moreover, although parameters whose values being set according to each access category, such as AIFS, CWmin and CWmax, can be set independently by a communication group (which is a basic service set (BSS) in IEEE802.11 wireless LAN), the default values are defined.

For example, in the definition of 802.11ac, with an assumption that SIFS is 16 μs and the slot time is 9 μs, and thereby PIFS is 25 pis, DIFS is 34 μs, the default value of the frame interval of an access category of BACKGROUND (AC_BK) in AIFS is 79 μs, the default value of the frame interval of BEST EFFORT (AC_BE) is 43 μs, the default value of the frame interval between VIDEO(AC_VI) and VOICE(AC_VO) is 34 μs, and the default values of CWmin and CWmax are 31 and 1023 in AC_BK and AC_BE, 15 and 31 in AC_VI and 7 and 15 in AC_VO. Here, EIFS denotes the sum of SIFS, DIFS, and the time length of a response frame transmitted at the lowest mandatory physical rate. In the wireless communication device which can effectively takes EIFS, it may estimate an occupation time length of a PHY packet conveying a response frame directed to a PHY packet due to which the EIFS is caused and calculates a sum of SIFS, DIFS and the estimated time to take the EIFS.

The terms used in each embodiment should be interpreted broadly. For example, the term “processor” may encompass a general purpose processor, a central processing unit (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, or one or more microprocessors in conjunction with a DSP core.

As another example, the term “memory” may encompass any electronic component which can store electronic information. The “memory” may refer to various types of media such as a random access memory (RAM), a read-only memory (ROM), a programmable read-only memory (PROM), an erasable programmable read only memory (EPROM), an electrically erasable PROM (EEPROM), a non-volatile random access memory (NVRAM), a flash memory, and a magnetic or optical data storage, which are readable by a processor. It can be said that the memory electronically communicates with a processor if the processor read and/or write information for the memory. The memory may be arranged within a processor and also in this case, it can be said that the memory electronically communication with the processor. The term “circuitry” may refer to not only electric circuits or a system of circuits used in a device but also a single electric circuit or a part of the single electric circuit. Moreover, the term “circuitry” may refer one or more electric circuits disposed on a single chip, or may refer one or more electric circuits disposed on a plurality of chips more than one chip or a plurality of devices in a dispersed manner.

In the specification, the expression “at least one of a, b or c” is an expression to encompass not only “a”, “b”, “c”, “a and b”, “a and c”, “b and c”, “a, b and c” or any combination thereof but also a combination of at least a plurality of same elements such as “a and a”, “a, b and b” or “a, a, b, b, c and c”. Also, the expression is an expression to allow a set including an element other than “a”, “b” and “c” such as “a, b, c, and d”.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

1. A wireless communication device comprising:
a memory configured to store a plurality of radiation pattern selection policies on an antenna capable of changing a radiation pattern; and
processing circuitry configured to detect an interference signal of a first channel by analyzing a signal received via the antenna; and select the radiation pattern selection policy from among the plurality of radiation pattern selection policies based on the interference signal of the first channel and change the radiation pattern of the antenna in accordance with the selected radiation pattern selection policy.

2. The wireless communication device according to claim 1, wherein
the processing circuitry is configured to judge whether an occurrence source of the interference signal is a device belonging to a predetermined category by analyzing the received signal; and
the processing circuitry is configured to select a first policy from among the plurality of radiation pattern selection policies when judging that the occurrence source is a device belonging to the predetermined category and select a second policy different from the first policy when judging that the occurrence source is not a device belonging to the predetermined category.

3. The wireless communication device according to claim 1, wherein the processing circuitry is configured to judge whether a ratio of a period during which the interference signal is detected within a first period is equal to or above a predetermined value, select a first policy from among the plurality of radiation pattern selection policies when the ratio is equal to or above the predetermined value and select a second policy different from the first policy when the ratio is below the predetermined value.

4. The wireless communication device according to claim 2, wherein the first policy prescribes that a radiation pattern is to be randomly selected from among a plurality of radiation patterns.

5. The wireless communication device according to claim 2, wherein the first policy prescribes that a radiation pattern having directivity in a direction toward an interference source in the first channel is to be selected.

6. The wireless communication device according to claim 2, wherein the second policy prescribes that a radiation pattern is to be selected based on a history of communication performed in each of the plurality of radiation patterns.

7. The wireless communication device according to claim 2, wherein the second policy prescribes that communication quality of each of the plurality of radiation patterns is to be measured and a radiation pattern is to be selected according to the measured communication quality.

8. The wireless communication device according to claim 2, wherein
the processing circuitry is configured to control communication in accordance with a communication scheme in which carrier sensing on a wireless medium is performed and when the state of the wireless medium is idle, transmission is allowed; and
the processing circuitry is configured to increase a threshold for reception judgment in the carrier sensing when the first policy is selected.

9. The wireless communication device according to claim 1, comprising a communicator configured to transmit first information notifying that the first channel is to be switched to a second channel, via the first channel after the radiation pattern of the antenna is changed.

10. The wireless communication device according to claim 9, wherein the processing circuitry is configured to switch the first channel to the second channel after the first information is transmitted.

11. The wireless communication device according to claim 1, comprising the antenna.

12. A wireless communication terminal comprising:
at least one antenna capable of changing a radiation pattern;
a receiver coupled with the antenna and configured to receive a frame;
a transmitter coupled with the antenna and configured to transmit a frame;
a communication processor coupled with the receiver and the transmitter;
a network processor coupled with the communication processor and configured to transmit data to the communication processor and receive data from other devices; and
a memory coupled with the network processor and configured to cache first data; wherein
the communication processor is configured to detect an interference signal of a first channel by analyzing a signal received via the antenna, decide a radiation pattern selection policy based on the interference of the first channel, and change the radiation pattern of the antenna in accordance with the radiation pattern selection policy;
the transmitter is configured to transmit a first frame via the antenna with the changed radiation pattern; and
the first frame includes the first data cached in the memory or information based on the first data.

13. A wireless communication method comprising:
detecting an interference signal of a first channel by analyzing a signal received via an antenna capable of changing a radiation pattern; and
deciding a radiation pattern selection policy based on the interference signal of the first channel;
change the radiation pattern of the antenna in accordance with the radiation pattern selection policy.

14. The method according to claim 13, further comprising
judging whether an occurrence source of the interference signal is a device belonging to a predetermined category by analyzing the received signal; and
selecting a first policy from among a plurality of radiation pattern selection policies when judging that the occurrence source is a device belonging to the predetermined category and selecting a second policy different from the first policy when judging that the occurrence source is not a device belonging to the predetermined category.

15. The method according to claim 13, further comprising
judging whether a ratio of a period during which the interference signal is detected within a first period is equal to or above a predetermined value, selects a first policy from among a plurality of radiation pattern selection policies when the ratio is equal to or above the predetermined value and selecting a second policy different from the first policy when the ratio is below the predetermined value.

16. The method according to claim 14, wherein the first policy prescribes that a radiation pattern is to be randomly selected from among a plurality of radiation patterns.

17. The method according to claim 14, wherein the first policy prescribes that a radiation pattern having directivity in a direction toward an interference source in the first channel is to be selected.

18. The method according to claim 14, wherein the second policy prescribes that a radiation pattern is to be selected based on a history of communication performed in each of the plurality of radiation patterns.

19. The method according to claim 14, wherein the second policy prescribes that communication quality of each of the plurality of radiation patterns is to be measured, and a radiation pattern is to be selected according to the measured communication quality.

20. The method according to claim 14, further comprising
controlling communication in accordance with a communication scheme in which carrier sensing on a wireless medium is performed and when the state of the wireless medium is idle, transmission is allowed; and
increasing a threshold for reception judgment in the carrier sensing when the first policy is selected.
